(19) United States
(12) Patent Application Publication
(10) Pub. No.: US 2020/0058004 A1
(43) Pub. Date: Feb. 20, 2020

(54) System and Method of Guarantee Payments

(71) Applicant: Joseph A. Ruggirello, Macomb, MI (US)

(72) Inventor: Joseph A. Ruggirello, Macomb, MI (US)

(21) Appl. No.: 16/544,896

(22) Filed: Aug. 19, 2019

Related U.S. Application Data
(60) Provisional application No. 62/719,671, filed on Aug. 19, 2018.

(51) Int. Cl. G06Q 20/10; H04L 9/08; G06Q 20/08; G06Q 20/38; G06Q 20/40; G06Q 40/00

(52) U.S. Cl. CPC G06Q 20/102; H04L 9/085; G06Q 20/085; G06Q 2220/00; G06Q 20/385; G06Q 20/40145; G06Q 40/125; G06Q 20/3829

(57) ABSTRACT

A system comprising: a computing device including a processor and a memory, the memory storing instructions executable by the processor such that the processor is programmed to input information of at least one of a financed project, a purchase, a loan, a patron, a loan amount, a project approver, a contractor, a supplier, an amount of money in escrow and a third-party escrow entity, collect and manage disbursements.

### CROSS-REFERENCE TO RELATED APPLICATIONS

The subject patent application claims priority to and all the benefits of U.S. Provisional Patent Application No. 62/719,671 which was filed on Aug. 19, 2018, which is herein incorporated by reference in its entirety.

### BACKGROUND

The present invention relates to systems and methods for accelerating payments to contractors and material suppliers, relative to a normal payment workflow during the course of a hierarchically organized construction project or any pay for performance scheduled payment.

Because of the increased certainty provided by the technological implementation described herein, General Contractors and third-party Funding Organizations can extend payments to the Subcontractor on an accelerated timeline relative to a normal payment schedule. For example, in “pay-when-paid” arrangements, the system allows for payments to Subcontractors to be made before payments are received from the Project Owner. Furthermore, as again described further below, the construction project funding system provides regulated access to select project source data and project summary data to allow the General Contractor and the Funding Organization to manually verify project metrics prior to approving and initiating an accelerated payment to a Subcontractor. This project data is accessed from the same system that provides for the budget reconciliation and invoice certainty noted above but is provided without compromising the confidentiality of other project data maintained on the server.

Moreover, by interacting with data stored on a Subcontractor prequalification database, the construction project funding system can provide a General Contractor and a Funding Organization with source data, self-reported Subcontractor data, and independent review/reporting data regarding the practices and capabilities of the Subcontractor. This information is readily available on the system described herein, but is not readily accessible from any publicly available source. As such, the construction project funding system allows a Funding Organization and a General Contractor to make informed decisions based on routinely updated information without the delay and possibility of tampering associated with collecting that information from the Subcontractor directly.

### BRIEF DESCRIPTION OF THE DRAWINGS

FIG. 1 is a block diagram of an exemplary computer system;

FIG. 2 is a process flow diagram of a user logging on to an exemplary system;

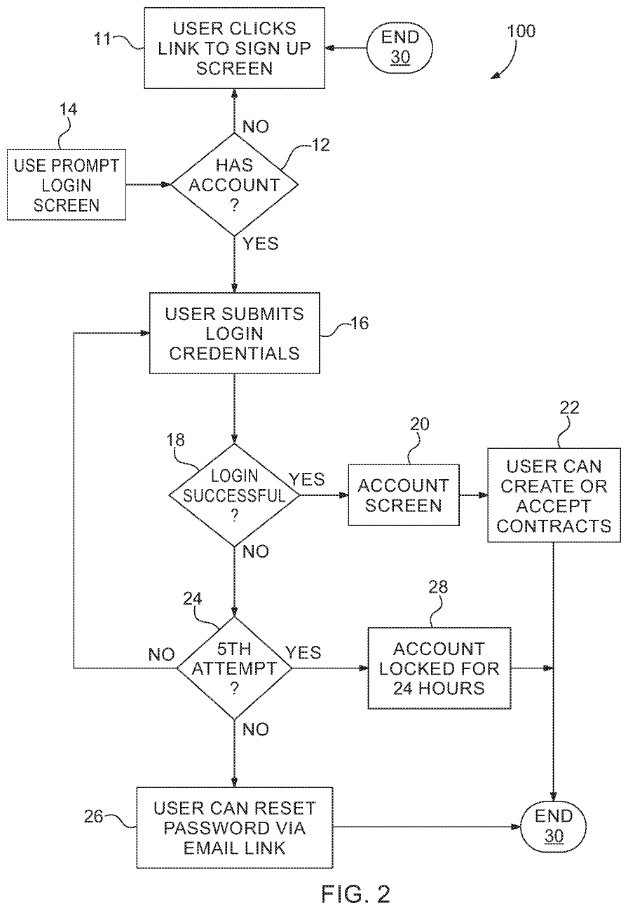

FIG. 3A is a process flow diagram of a buyer and a seller entering contract parameters;

FIG. 3B is a continuation of FIG. 3A;

FIG. 4A is a process flow diagram of a buyer and a seller entering revising the contract parameters;

FIG. 4B is a continuation of FIG. 4A;

FIG. 5 is an example of a process flow diagram of a Buyer;

FIG. 6 is a process flow diagram of an example process of a dispute in the contract;

FIG. 7 is a process flow diagram of an example process of both parties uploading images and video to a server;

FIG. 8 illustrates an identification parameter data storage flow as a new user signs up to use the funding system.

### DETAILED DESCRIPTION

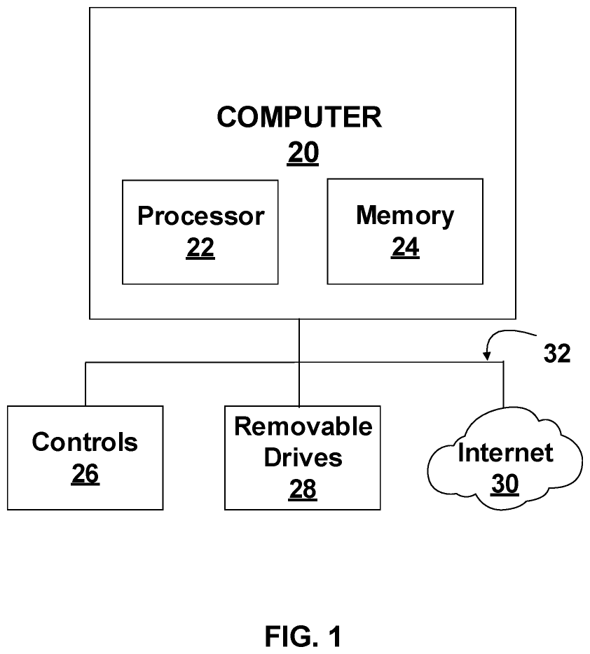

With reference to FIG. 1, a computer 50 includes a processor 52 and a memory 54. The memory 54 of the computer 50 may include memory for storing instructions executable by the processor 52 as well as for electronically storing data and/or databases. The computer 50 may receive input via controls 56 such as a keyboard and/or a mouse; via removable drives 58 such as USB drives; via a network connection 60 to, e.g., a wide area network (WAN) 62 typically including the Internet; or via any other means for transferring data to the computer 50. Although one computer 50 is shown in FIG. 1 for ease of illustration, it is to be understood that the computer 50 could include, and various operations described herein could be carried out by, one or more computing devices.

A list of information that that a contract keeper need is the system may be details of a financed project, a purchase, a loan, a patron, a loan amount, a project approver, a contractor, a supplier, an amount of money in escrow, a milestone, a cost of material, a permit fee, a metric, a license fee, a bonus fee, a third-party escrow entity and a project approver, which can be a homeowner or a job site foreman. It should be noted that the system can be deployed in most situations requiring an escrow.

An embodiment of the process 100 begins in a block 11 where a user Clicks a link to a sign-up screen. Next in a decision block 12, the system checks to see if the user has an account. If the user does have an account, the process 100 continues to in a block 16. If the user does not have an account, the process 100 continues back to in a block 11. Alternatively, the user can be prompted at another login entry point at in a block 14. At in the block 16 the user submits a login credential. the output of in a block 16 continues to a decision block 18. If the login was successful, the process 100 continues to in a block 20. If the login wasn't successful, the process 100 continues to a decision block 24. At in the block 24, Hey counter detects the number of login attempts. If this is not the 5th attempt, the process 100 returns to enable block 16 to permit the user to reenter their credentials. If it is the fifth attempt at trying to log in, the process 100 continues to in a block 28. In the block 28 the process 100 locks, out the account for 24 hours. The output of in the block 28 goes through a Terminator block 30 and this process 100 ends. If it is not the fits attempt the process 100 will offer the user the option to reset their password in a block 26, The output of block 26 also terminates at in the block 30. A successful login at in the block 18 permits the user to see their account screen at in the block 20. The output of in the block 20 has the process 100 continuing to in a block 22. At in the block 22 the user can create our accept contracts. The output of in the block 22 continues to the end block 30.

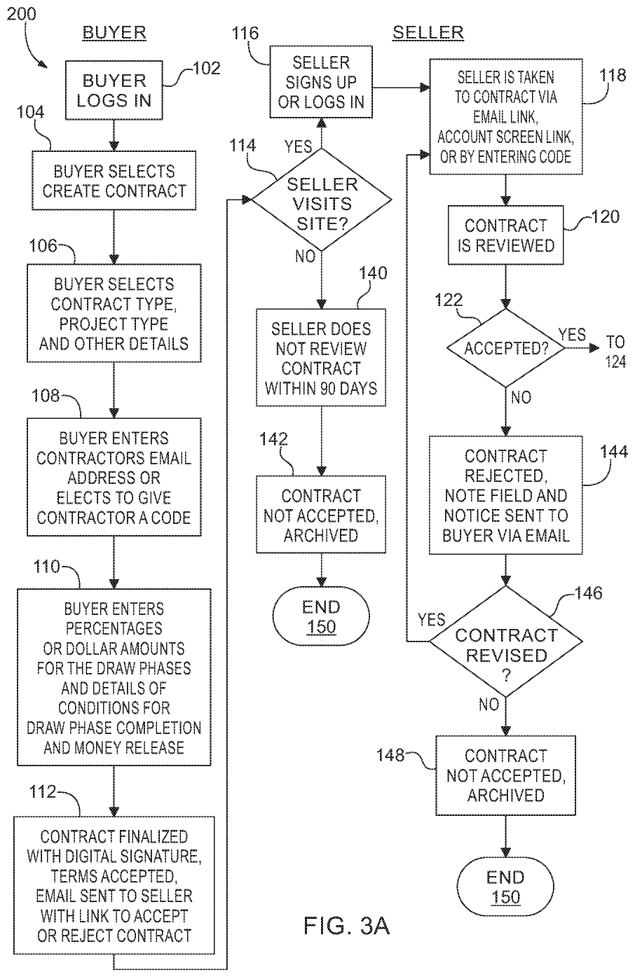

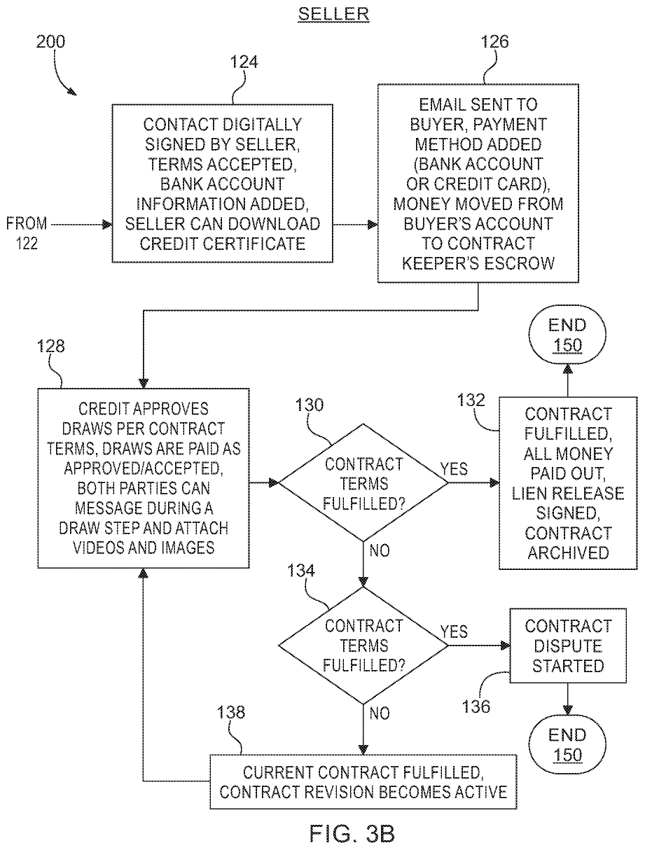

FIG. 3A is a flow diagram of a process 200 in which a buyer, who can be a purchaser, a homeowner or anyone needing to have monies held in escrow for a service or goods. The seller can be a contractor, a goods and material supplier or sub-contractor. The process 200 has the buyer and seller entering contract parameters. In a block 102 the buyer logs in. The process 200 continues to in a block 104. At this point the buyers can create a new contract. The process continues to in a block 106, where the buyer can select the contract type the project type and other details relating to the contract. The process 200 continues to in a block 108, where are the buyer enters the contractors email address or elects to give the contractor a code, such as a qr code. The process 200 continues to in a block 110 where there by or enters percentages or dollar amounts for the draw, phases and details of conditions for completion, such as milestones and went to release the money. The process 200 continues to in a block 112, where the contract is finalized with digital signatures a set of terms are accepted an email sent to the seller with a link to accept or reject the contract. The process 200 continues to in a decision block 114. The decision block 114 determines if the seller ever visited the contract website. If the seller has visited the contract website; the process 200 continues to in a block 116. If the seller has not visited the contract website, the process 200 continues to in a block 140. At in the block 140, The process 200 determines if the seller has reviewed the contract within 90 days. The process 200 continues two in a block 142, or the contract is determined to be not accepted and is archived. The process continues to a termination block 150 and process 200 ends. At in a block 116 the seller can sign up to the contract website or login If the seller already has an account. The process 200 continues to block 118, where this seller is taken to a contract by email link are to and account screen link or by entering a cold code the seller has received ny email or a text. The process 200 continues to in a block 120 or the contractors reviewed. The process continues to a decision block 122 as shown on FIG. 3B where it is determined whether the contract was accepted or not if the contract was accepted the process 200 continues to in a block 124 if the contract was rejected the process 200 continues to in a block 144. In the block 144 the process 200 sends rejected contract, noting data fields which cam contain reasons for the rejection, by email to the buyer. The process 200 continues to a decision block 146. In the decision block 146, process 200 determines whether the contract is revised, if it is the process 200 returns to in the block 118. If the contract was not revised, the process continues onto in a block 148 in which the contract is noted as not being accepted and is archived, the process 200 continues to an end block 150 and process 200 terminates.

The positive output of decision block 122 has the process 200 going over 2 in a block 124. In the block 124 the contract is digitally signed by the seller a set of terms are accepted and a bank account information is added, and this sour can download a credit certificate. The process 200 continues to in a block 126 in which an email sent to the buyer a payment method is added, for example a credit card or wire transfer. Money is moved from the buyers account to a contract keeper escrow account. The process 200 continues to in a block 128 in which the contract keeper enables a credit and approves a draws per contract, and set a terms, when draws are to be paid and how The draws are to be determined, for example percentage of work completed are having materials delivered on site. Both parties can message during a draw step and attach videos and images.

The process 200 continues to in a block 130 In which the process to counter determines if the contract terms are being fulfilled. If they are not being fulfilled the process 200 continues to in a block 134. At the contact terms are being fulfilled the process 200 continues to in a block 132 at in a block 132 the process 200 determines if the contract was completely filled and if all monies are paid out, releases all liens and a signed contract is archived. The process 200 then continues to end block 150 and process 200 terminates. That indecision block 134 another determination is made about the contract terms. If the contract terms are fulfilled the process continues to in a block 136 and a contract dispute is started. The output of in a block 136 continues to the unblock 150. If the contract terms are not fulfilled the current contract is determined is still being active and the process 200 continues to in a block 128.

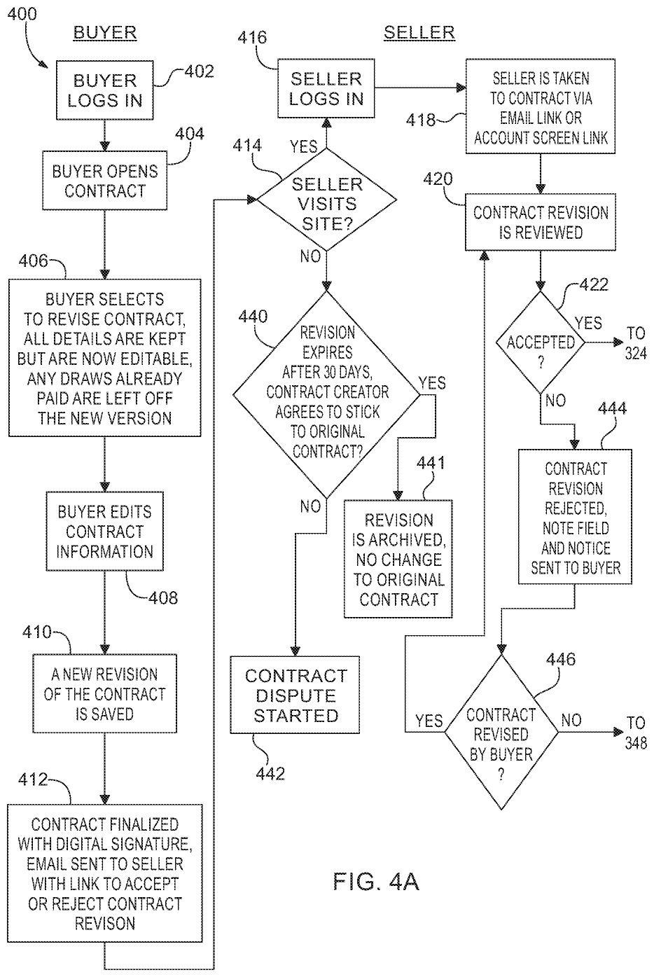

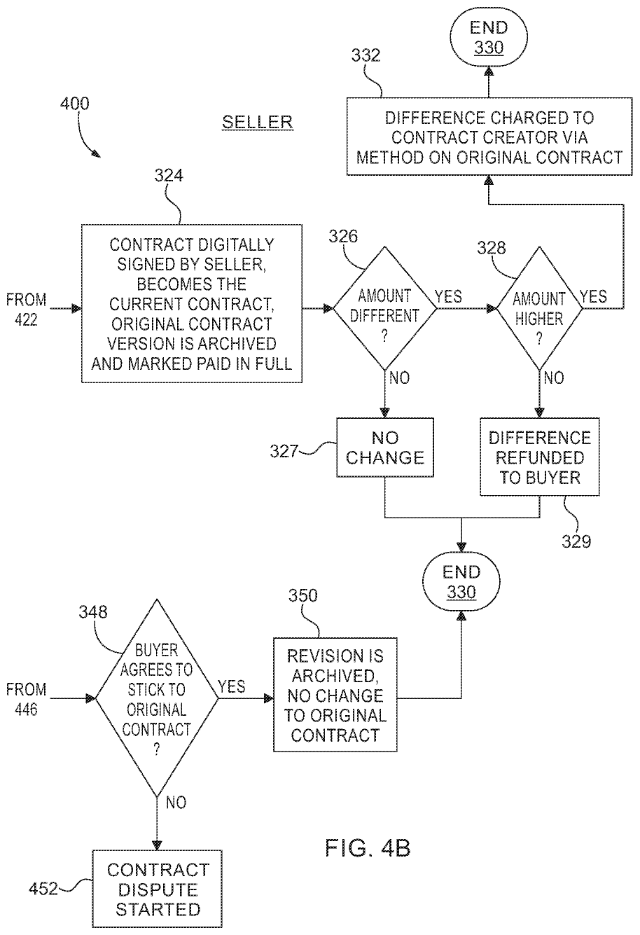

FIG. 4A is a flow diagram of a process 400 in which a buyer or a seller can request a revision to their contract. The process 400 begins in a block 402 in which a buyer logs in the process 400 continues to in a block 404 in which the buyer opens the contract the process 400 continues to in a block 406 where the buyer selects to revise the contract, the new details are stored, but they are editable and any draws already paid are left off the new version. The process for 100 continues to in a block 408 in which the buyer edits the contract's information. The process 400 then continues to in a block 410 and a new revision of the contract is saved the process continues to in a block 412 where the contract is finalized with a digital signature an email sent to the seller with a link to either accept or reject the revision. The process 400 continues into a decision block 414. If the seller visits the contract keeper website, the process continues to in a block 416 in which the seller logs in. The process continues to in a block 418 where the sellers taken to a revised contract via email link or is shown the revised contract on an account screen. To process 400 canoes into in a block 420 in which the contract revision is reviewed the process continues to a decision box 422. The process 400 determines if the fire has accepted the terms of the revised contract and if so the process 400 continues to in a block 324. If the buyer has rejected the revised contract process continues to in a block 444 in which the contract revision is rejected a note is filed in a file history and a notice is sent to the buyer. The process 400 continues into a decision block 446. In Decision block 446 the buyer has an opportunity to revise the contract. If the buyer decides to revise the contract the process continues returns 2 in a block for 20 in which the contract revision is reviewed. If the fired do not revise the contract the process 400 continues to in a block 348.

If the seller does not visit the contract keeper's website, the process continues to a decision block 440. In block 440 the process determines if it's more than 30 days and if the contract creator agrees to stick to the original contract. If the decision is negative Hey contract dispute it started in a block 442. If the contract creator agrees to stick to the original contract the process continues into a block 441 in which the contract revision is archived and there is no change to the original contract.

In a block 324 the contract is digitally signed by the seller and becomes the current contract, the original contract virgins are archived and marked paid in full. Process 400 continues into a decision block 326 in which a determination is made about the amount of money. If the amount is different from the original contract the process 400 continues IN28 another decision block 328. If the amount is higher the process 400 continues two in a block 332 in which the difference charge to contract creator by the original contract method. The process 400 continues in and set process Terminator 3:30 referring back to in the block 326, if there is no change in amount the process 400 continues to in a block 327 in which no changes memorialized in the contract keepers reference file. The process then terminates at end Terminator block 3:30 referring back to decision block 328 if the amount is not higher, the process 400 continues to in a block 329 in which a difference is refunded to the buyer the process continues to end block 3:30. Referring back too in a decision block 348 a decision is made if the buyer Greece who stick to the original contract. If the buyer agrees to stick to the original contract the process 400 continues to in a block 350 in which revision is archived no change to the original contract is made. The process then terminates at in determination block 3:30 if the buyer doesn't want to agree with the original contract the process 400 continues to in a block 452 in which the contract dispute is started.

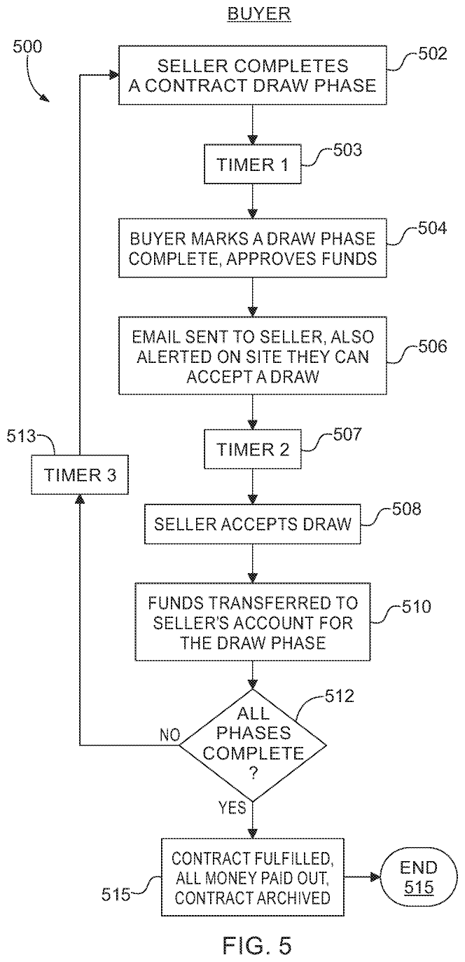

FIG. 5 is a simplified block diagram showing how a seller request a draw from the buyer in a process 500. The process 500 begins in a block 502 in which this hour completes a contract draw phase the process continues to in a block 503 in which a timer 1 is initiated. The process continues to in a block 504 in which the buyer marks a draw phase complete an approved the funds. The process then continues to in a block 506 and which an email sent to the seller Ann the seller is also alerted on the contract keepers website so they can accept the draw. The process continues to in a block 507 in which a second timer is started the process continues two in a block 5 weight in which the seller accepts the draw. Process continues to in a block 510 in which funds are transferred to the sellers account for that particular phase draw. The process continues to a decision block 512 which determines if all the phases are complete. In the block 512 the process determines that all the phases are not complete, the process continues to in a block 513 initiating a third timer the process then returns to in a block 502. If all the phases are complete process continues to be in a block 5 one five in which the contract is deemed fulfilled all monies are paid out and the contract is archived the process that continues to end block 515 and the process terminates.

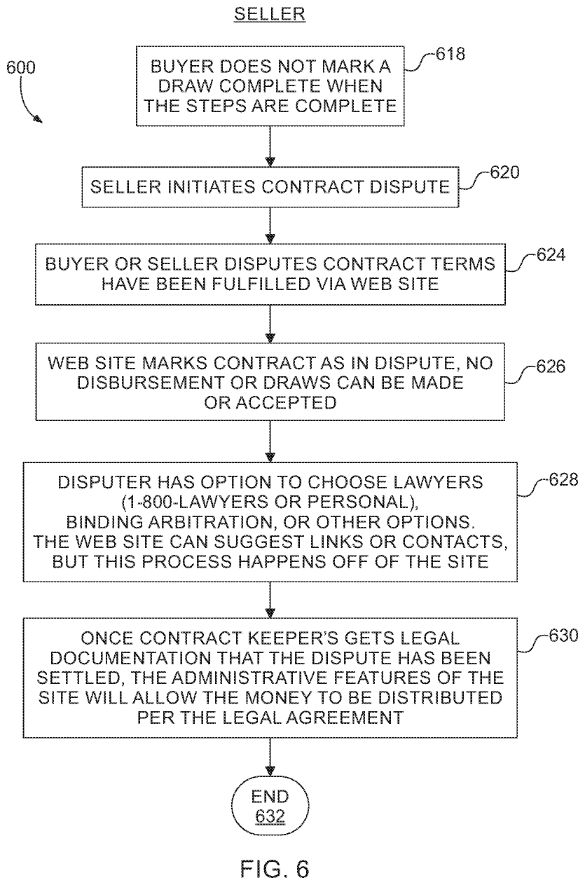

FIG. 6 is a simplified block diagram Illustrating a process 600. The process 600 starts in a block 618 in which the buyer does not mark That is certain phase of the project is deemed not complete. The process continues onto in a block 6:20 and which is seller initiates a contract dispute the process continues to in a block 624 in which the buyer or seller dispute the contract terms have been fulfilled via the contract keeper website. The process continues to in a block 626 in which website marks contract as in dispute indicating that no disbursements are drawls can be made or accepted. The process 600 continues to a block 628 in which it is Peter has options to choose lawyers, binding arbitration or other options. The website can suggest winks or Contacts of arbitrators, lawyers are even magistrates, but the contract keeper will not participate in any resolution. The process 600 continues to in a block 6:30 Ann once the contract keeper gets legal documentation that the dispute has been settled the administrative features will allow the money keep disputed per day legal agreement the process continues to in a termination block 632.

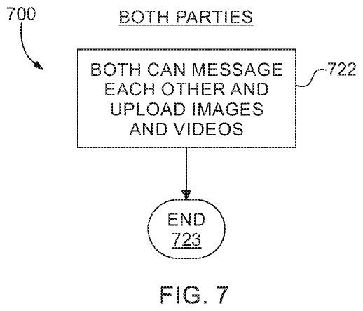

FIG. 7 who illustrates a process 700 in which both parties can message each other in a block 722 they can Additionally upload images and videos the processes in terminated in an end block 723.

A project funding system configured for processing payments associated with a financed project and a purchase, for example, a construction project, wherein an escrow holding funding source distributes a payment, the project funding system The system has a processor and a memory comprising instructions that, when executed by the processor, cause the processor to create a master payment code for said escrow holding funding source. The processor also creates in a storage device a table entry for said financed project and a project approver.

The project funding system assigns to a one or more participants a unique request for payment code and transmit each unique request for payment code to said one or more participants, wherein each payment code is stores in said storage device. The master payment code, a project budget for the financed project including a contract amount, a plurality of contract line items, and a plurality of budget line items indicative of work performed in association with the financed project, each contract line item including a value and each budget line item includes a value is stored.

Additionally, a plurality of the budget line items to one of the contract line items corresponding to work whose performance in association with the financed project is indicated by the plurality of budget line items.

The system receives at least one or more participants including a first participant associated with the project, a batch of requests for payment for services or materials provided in connection with the financed project, the batch of requests for payment including a plurality of requested payment amounts;

The systems receives, from said one or more participants, a request for payment, wherein said one or more participants request an approval for a payment based on a review of a first project metric, and in response to receiving the approval of the payment, the escrow holding funding source determines: (i) a sum of the values for each of the contract line item equals the contract amount; and (ii) a sum of the values of a plurality of first budget line items indicative of first work performed in association with a first contract line item of the plurality of contract line items equals the value of the first contract line item.

The system transmits in response to determining that the master payment code for said escrow holding funding source has been received and allows submission of an approval of the requests for payment.

The system transmits, via a network communication, a payment instruction to a remote computer associated with the escrow funding source, wherein the payment instruction causes the escrow funding source to electronically provide an payment for the requested payment amount to a designated destination.

In an embodiment, the project funding system permits a different participant, such as a second participant, a third participant, etc. For example, the first participant is a sub-contractor or materials supplier for the financed project, and wherein the second participant is a general contractor on the financed project.

The project funding system can include a first project metric, which is automatically generated by the project funding system. For example, the first project metric includes whether the first participant is in contractual compliance with respect to the financed project or the first project metric may be whether the first participant is the correct entity to receive payment in response to the request for payment.

Another example of the first project metric can include confirmation of whether the materials or services for which payment is being requested have been delivered or completed.

The project funding system can include a server comprising the processor and processes both payments and ordinary payments made in an ordinary course of the financed project.

The project funding system can allow at least one participant to select to process a request for payment either as an accelerated payment or as an ordinary payment. An accelerated payment is a payment ahead of the agreed upon terms of the project.

The project funding system may also permit the server to automatically select whether to process a request for payment as an accelerated payment or as an ordinary payment based on evaluation of project metrics or first participant data.

The project funding system may also permit the server to allow a selection to process a request for payment as either an accelerated payment or an ordinary payment to be performed in response to each request for payment.

The project funding system may also permit the server to allow a selection to process a request for payment as either an accelerated payment or an ordinary payment to be done for an entire project or contract.

The project funding system includes a third-party funding source, such as a financial institution, and wherein a funding approval received from the third-party funding source indicates that a payment obligation has been assumed by a second participant associated with the financed project and that the accelerated payment to the first participant will be repaid to the third-party funding source by the second participant.

The project funding system needs a funding approval from a third-party funding source establishes an obligation on the second participant associated with the financed project to pay the third-party funding source.

The project funding system may also permit the server to allow a selection of a timing of the payment.

The project funding system may also permit the server to allow funding approval from the third-party funding source to be performed for an entire project.

The project funding system may also permit the server to monitor a time schedule, which can affect the amount of the payment.

The project funding system may also permit the server to receive requests for payment to include requests for an accelerated payment for work performed by the first participant for the second participant.

The project funding system may also permit the server to issue the master payment code and said unique request for payment code. The codes can be at least one of a barcode, a qr code, a one-factor authentication code, a two-factor authentication code, and a three-factor authentication code. The codes may be encrypted with at least of key type including a private signature key, a public signature verification key, a symmetric authentication key, a private authentication key, a public authentication key, a symmetric data encryption key, a symmetric key wrapping key, a symmetric master key, a private key transport key, a public key transport key, a symmetric key agreement key, a private static key agreement key, public static key, a private ephemeral key agreement key, a public ephemeral key agreement key, a symmetric authorization key, a private authorization key, and a public authorization key.

Types of Keys

Private Signature Key

Private signature keys are the private keys of asymmetric (public) key pairs that are used by public key algorithms to generate digital signatures with possible long-term implications. When properly handled, private signature keys can be used to provide authentication, integrity and non-repudiation.

Public Signature Verification Key

A public signature verification key is the public key of an asymmetric key pair that is used by a public key algorithm to verify digital signatures, either to authenticate a user's identity, to determine the integrity of the data, for non-repudiation or a combination thereof.

Symmetric Authentication Key

Symmetric authentication keys are used with symmetric key algorithms to provide assurance of the integrity and source of messages, communication sessions or stored data.

Private Authentication Key

A private authentication key is the private key of an asymmetric key pair that is used with a public key algorithm to provide assurance as to the integrity of information, and the identity of the originating entity or the source of messages communication sessions, or stored data.

Public Authentication Key

A public authentication key is the public key of an asymmetric key pair that is used with a public key algorithm to determine the integrity of information and to authenticate the identity of entities, or the source of messages, communication sessions, or stored data.

Symmetric Data Encryption Key

These keys are used with symmetric key algorithms to apply confidentiality protection to information.

Symmetric Key Wrapping Key

Symmetric key wrapping keys are used to encrypt other keys using symmetric key algorithms. Key wrapping keys are also known as key encrypting keys.

Symmetric and Asymmetric Random Number Generation Keys

These are keys used to generate random numbers.

Symmetric Master Key

A symmetric master key is used to derive other symmetric keys (e.g., data encryption keys, key wrapping keys, or authentication keys) using symmetric cryptographic methods.

Private Key Transport Key

Private key transport keys are the private keys of asymmetric key pairs that are used to decrypt keys that have been encrypted with the associated public key using a public key algorithm. Key transport keys are usually used to establish keys (e.g., key wrapping keys, data encryption keys or MAC keys) and, optionally, other keying material (e.g., initialization vectors).

Public Key Transport Key

Public key transport keys are the public keys of asymmetric key pairs that are used to encrypt keys using a public key algorithm. These keys are used to establish keys (e.g., key wrapping keys, data encryption keys or MAC keys) and optionally, other keying material (e.g., Initialization Vectors).

Symmetric Key Agreement Key

These symmetric keys are used to establish keys (e.g., key wrapping keys, data encryption keys, or MAC keys) and, optionally, other keying material (e.g. Initialization Vectors) using a symmetric key agreement algorithm.

Private Static Key Agreement Key

Private static key agreement keys are the private keys of asymmetric key pairs that are used to establish keys (e.g., key wrapping keys, data encryption keys, or MAC keys) and, optionally, other keying material (e.g., Initialization Vectors).

Public Static Key Agreement Key

Public static key agreement keys are the public keys of asymmetric key pairs that are used to establish keys (e.g., key wrapping keys, data encryption keys, or MAC keys) and, optionally, other keying material (e.g., Initialization Vectors).

Private Ephemeral Key Agreement Key

Private ephemeral key agreement keys are the private keys of asymmetric key pairs that are used only once to establish one or more keys (e.g., key wrapping keys, data encryption keys, or MAC keys) and, optionally, other keying material (e.g. Initialization Vectors).

Public Ephemeral Key Agreement Key

Public ephemeral key agreement keys are the public keys of asymmetric key pairs that are used in a single key establishment transaction to establish one or more keys (e.g., key wrapping keys, data encryption keys, or MAC keys) and optionally, other keying material (e.g., Initialization Vectors).

Symmetric Authorization Key

Symmetric authorization keys are used to provide privileges to an entity using a symmetric cryptographic method. The authorization key is known by the entity responsible for monitoring and granting access privileges for authorized entities and by the entity seeking access to resources.

Private Authorization Key

A private authorization key is the private key of an asymmetric key pair that is used to provide privileges to an entity.

Public Authorization Key

A public authorization key is the public key of an asymmetric key pair that is used to verify privileges for an entity that knows the associated private authorization key.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

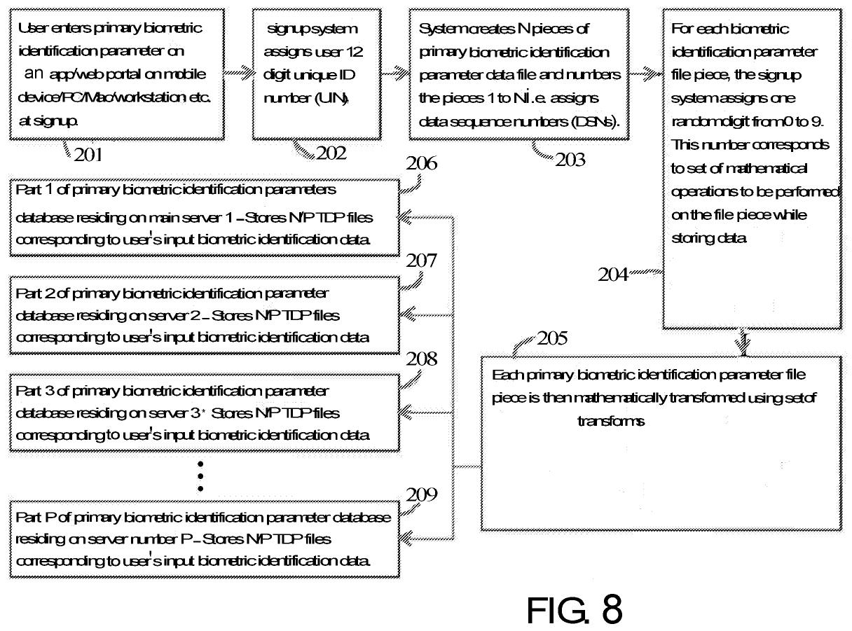

FIG. 8 illustrates an identification parameter data storage flow as a new user signs up to use the funding system. In a block 201, at sign-up, a user enters a primary biometric identification on a device using an app, or a web portal accessed from a device such as a smartphone, tablet, laptop computer, desktop computer, workstation or some other computing system. In a block 202, the device or the web portal assigns the user a unique identification number (UIN). For example, the UIN can be an integer having sixteen digits. In a block 203, the system parses a user's input biometric identification data by parsing the user's biometric identification parameter data file into N number of pieces. For example, each biometric identification parameter data file piece receives a data sequence number (DSN) from 1 to “N” where “N” is the number of pieces. In a block 204, for each biometric identification parameter file piece, the signup system assigns one random digit from 0 to 9. This number corresponds to the set of mathematical operations to be performed on the file piece while storing data. This random number is called an encryption digit. In a block 205, each primary biometric identification parameter file piece is then mathematically changed using a set of transforms associated with the corresponding encryption digit. The truncated data file is then named with an id type. The type of biometric parameter to be used can be a fingerprint, a retina scan or any other type of biometric parameter.

The “N” pieces are stored on “P” servers, where “N” is greater than “P” and where each server stores N/P pieces. For example, block 206 represents part one of the primary biometric identification parameter database residing on a first main server that stores N/P transformed data piece (TDP) files corresponding to the user's input biometric identification data. Block 207 represents part two of the primary biometric identification parameter database residing on a second server that stores N/P TDP files corresponding to the user's input biometric identification data. Block 208 represents part three of the primary biometric identification parameter database residing on a third server that stores N/P TDP files corresponding to the user's input biometric identification data. And so on until block 209 represents part “P” of the primary biometric identification parameter database residing on a “Pth” server that stores N/P TDP files corresponding to the user's input biometric identification data.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, C#, Visual Basic, Java Script, Perl, HTML, Python, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random-access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising: a computing device including a processor and a memory, the memory storing instructions executable by the processor such that the processor is programmed to:
input information of at least one of a financed project, a purchase, a loan, a patron, a loan amount, a project approver, a contractor, a supplier, an amount of money in escrow and a third-party escrow entity;
create and assign a unique payment code for at least one task to at least one of the patron, the project approver, the contractor and the supplier;
transmit a first signal to each unique payment code to said at least one of the patron, the project approver, the contractor and the supplier;
receive a second signal from said at least one of the contractor and the supplier, thereby indicating the at least one task is complete;
receive a third signal from at least one of the patron and the project approver affirming the at least one task is complete;
determine the if said second signal and the second signal codes authorize a payment to at least one of the contractor and the supplier; and
transmit the payment to at least one of the contractor and the supplier.

2. The system of claim 1, wherein the at least one task is at least one of a milestone, a cost of material, a permit fee, a metric, a license fee and a bonus fee.

3. The system of claim 1, wherein the computing device is configured to allow a request for an accelerated payment, wherein the processor is programmed to:
receive a fourth signal with an accelerated payment request from to at least one of the contractor and the supplier;
transmit a fifth signal to at least one of the patron and the project approver;
receive a sixth signal from at least one of the patron and the project approver affirming the accelerated payment request;
determine the if sixth signal authorizes the accelerated payment request; and
transmit the accelerated payment to at least one of the contractor and the supplier.

4. The system of claim 1, wherein the unique payment code is at least one of a barcode, a QR code, a one factor authentication code, a two-factor authentication code, and a three-factor authentication code.

5. The system of claim 4, wherein the code is encrypted in a key, wherein the key is at least one of a private signature key, a public signature verification key, a symmetric authentication key, a private authentication key, a public authentication key, a symmetric data encryption key, a symmetric key wrapping key, a symmetric master key, a private key transport key, a public key transport key, a symmetric key agreement key, a private static key agreement key, public static key, a private ephemeral key agreement key, a public ephemeral key agreement key, a symmetric authorization key, a private authorization key, and a public authorization key.

6. A method of using a computing device including a processor and a memory to operate a funding system, comprising:
storing an instruction in the memory;
executing by the processor said instructions such that the computing device;
inputting information of at least one of a financed project, a purchase, a loan, a patron, a loan amount, a project approver, a contractor, a supplier, an amount of money in escrow and a third-party escrow entity;
creating a unique payment code for at least one task to at least one of the patron, the project approver, the contractor and the supplier;
transmitting a first signal to each unique payment code to said at least one of the patron, the project approver, the contractor and the supplier;
receiving a second signal from said at least one of the contractor and the supplier, thereby indicating the at least one task is complete;
receiving a third signal from at least one of the patron and the project approver affirming the at least one task is complete;
determining the if said second signal and the second signal codes authorize a payment to at least one of the contractor and the supplier; and
transmitting the payment to at least one of the contractor and the supplier.

7. The method of claim 6, wherein the at least one task is at least one of a milestone, a cost of material, a permit fee, a metric, a license fee and a bonus fee.

8. The method of claim 6, wherein the computing device is configured to allow a request for an accelerated payment, wherein the processor is programmed to:
receiving a fourth signal with an accelerated payment request from to at least one of the contractor and the supplier;
transmitting a fifth signal to at least one of the patron and the project approver;
receiving a sixth signal from at least one of the patron and the project approver affirming the accelerated payment request;
determining the if sixth signal authorizes the accelerated payment request; and
transmitting the accelerated payment to at least one of the contractor and the supplier.

9. The method of claim 6, wherein the unique payment code is at least one of a barcode, a QR code, a one factor authentication code, a two-factor authentication code, and a three-factor authentication code.

10. The method of claim 9, wherein the code is encrypted in a key, wherein the key is at least one of a private signature key, a public signature verification key, a symmetric authentication key, a private authentication key, a public authentication key, a symmetric data encryption key, a symmetric key wrapping key, a symmetric master key, a private key transport key, a public key transport key, a symmetric key agreement key, a private static key agreement key, public static key, a private ephemeral key agreement key, a public ephemeral key agreement key, a symmetric authorization key, a private authorization key, and a public authorization key.

11. The method of claim 9 by which a transaction system verifies a biometric identification parameter used by the funding system to perform a transaction, the method comprising the following steps:
(a) receiving, from a user assigned a first user identification number and the biometric identification parameter;
(b) creating a plurality of pieces of an identification parameter data file;
(c) transforming a first piece into a first plurality of transformed verification pieces, each transformed verification piece resulting from encrypting the first piece using a mathematical encryption operation from a plurality of mathematical encryption operations, wherein the mathematical encryption operation used to encrypt the piece is different for each transformed verification piece in the first plurality of transformed verification pieces and wherein the first piece has a first data sequence number;
(d) searching an identity database for a stored transformed data piece that matches any transformed verification piece in the first plurality of transformed verification pieces;
(e) returning an identification failure when there is no stored transformed data piece that matches any transformed verification piece in the first plurality of transformed verification pieces;
(f) returning an identification failure when there is a stored transformed data piece that matches a transformed verification piece in the first plurality of transformed verification pieces, but a stored data sequence number stored with the stored transformed data piece does not match the first data sequence number, so that all files in the identification database where there is a stored transformed data piece that matches a transformed verification piece in the first plurality of transformed verification pieces, and a stored data sequence number stored with the stored transformed data piece that matches the first data sequence number, are current eligible files;
(g) transforming a second piece into a second plurality of transformed verification pieces, each transformed verification piece resulting from encrypting the second piece using a mathematical encryption operation from a plurality of mathematical encryption operations, wherein the mathematical encryption operation used to encrypt the piece is different for each transformed verification piece in the second plurality of transformed verification pieces and wherein the second piece has a second data sequence number;
(h) searching the current eligible files in the identity database for a stored transformed data piece that matches any transformed verification piece in the second plurality of transformed verification pieces;
(i) returning an identification failure when there is no stored transformed data piece that matches any transformed verification piece in the second plurality of transformed verification pieces;
(j) returning an identification failure when there is a stored transformed data piece that matches a transformed verification piece in the second plurality of transformed verification pieces, but a stored data sequence number stored with the stored transformed data piece does not match the second data sequence number, so that all files in the current eligible files where there is a stored transformed data piece that matches a transformed verification piece in the second plurality of transformed verification pieces, and a stored data sequence number stored with the stored transformed data piece that matches the second data sequence number, are now the current eligible files;
(k) repeating steps (g), (h), (i) and (j) for any remaining pieces in the plurality of pieces, until an identification failure is returned or until all remaining pieces in the plurality of pieces are processed without returning an identification failure; and,
(l) when steps (a) through (k) are performed without returning an identification failure, returning an identification success.

12. The method of claim 11, additionally comprising: verifying a secondary identification parameter when in step (l) an identification success is returned.

13. The method of claim 11 wherein steps (a), (b), (c) and (g) are performed by a transaction device that interacts directly with the user.

14. The method of claim 13 wherein steps (a), (b), (c) and (g) are performed by a transaction device that interacts directly with the user while step (d) and step (h) is accomplished using a transaction device interface server that is in communication with the transaction device.

15. The method of claim 13 wherein the identification parameter database is stored on a plurality of servers so that stored transformed data pieces are distributed among the plurality of servers.

16. The method of claim 13 wherein steps (a), (b), (c) and (g) are performed by a transaction device that interacts directly with the user while step (d) and step (h) is accomplished by the transaction device interface server communicating with the plurality of servers.

17. The method of claim 16 wherein steps (a) through (l) are repeated using a secondary identification parameter instead of the biometric identification parameter and using a secondary identification parameter data file instead of a primary biometric identification parameter data file.

18. The method of claim 13 wherein the identification parameter is a biometric identification parameter and the primary identity database is a biometric identification database.

19. A method of claim 13 wherein the identification parameter is a secondary identification parameter.

20. A project funding system configured for processing payments associated with a financed project, wherein an escrow holding funding source distributes a payment, the project funding system comprising:
store in a storage device instructions that, when executed by a processor cause the processor to:
create a master payment code for said escrow holding funding source;
create in the storage device a table entry for said financed project and a project approver;
assign to at least one or more participants a unique request for payment code and transmitting each unique request for payment code to said one or more participants wherein each payment code;
store, in said storage device, the master payment code, a project budget for the financed project including a contract amount, a plurality of contract line items, and a plurality of budget line items indicative of work performed in association with a construction project, each contract line item including a value and each budget line item includes a value;
assign a plurality of the budget line items to one of the contract line items corresponding to work whose performance in association with the financed project is indicated by the plurality of budget line items;
receive, from said one or more participants including a first participant associated with the project, a batch of requests for payment for services or materials provided in connection with the construction project, the batch of requests for payment including a plurality of requested payment amounts;
receive, from said one or more participants, a request for payment, wherein said one or more participants request an approval for a payment based on a review of a first project metric;
receive the approval of the payment;
determine
(i) a sum of the values for each of the contract line item equals the contract amount;
(ii) (ii) a sum of the values of a plurality of first budget line items indicative of first work performed in association with a first contract line item of the plurality of contract line items equals the value of the first contract line item; and transmitting in response to determining that the master payment code for said escrow holding funding source has been received;
allow submission of an approval of the requests for payment; and
transmit, via a network communication, an payment instruction to a remote computer associated with the escrow funding source; wherein the payment instruction causes the escrow funding source to electronically provide an payment for the requested payment amount to a designated destination.
